(19) United States
(12) Patent Application Publication
(10) Pub. No.: US 2004/0000999 A1
(43) Pub. Date: Jan. 1, 2004

(54) System and method for scanning carriers for objects

(76) Inventors: John E. Turner, El Paso, TX (US); Brian J. Turner, El Paso, TX (US); David F. Turner, El Paso, TX (US); Robert M. Turner, El Paso, TX (US); Charles Gorbet, El Paso, TX (US); Mitchell M. Truitt, Santa Fe, NM (US); Les R. Burk, El Paso, TX (US)

Correspondence Address: BAKER BOTTS L.L.P., 2001 ROSS AVENUE, SUITE 600, DALLAS, TX, 75201-2980, US

(21) Appl. No.: 10/290,856

(22) Filed: Nov. 8, 2002

Related U.S. Application Data
(60) Provisional application No. 60/344,863, filed on Nov. 8, 2001.
(60) Provisional application No. 60/355,615, filed on Feb. 5, 2002.

(51) Int. Cl. G08B 13/14

(52) U.S. Cl. 340/572.4

(57) ABSTRACT

A system and method for scanning carriers for objects include the capability to sense a radioactive object in the detection proximity of a platform and form a signal indicative thereof and to determine whether an illicit radioactive object may be in the detection proximity. The system and method also include the capability to sense a metallic object in the detection proximity of the platform and form a signal indicative thereof and to determine whether an illicit metallic object may be in the detection proximity.

### RELATED APPLICATIONS

This Application claims the benefit of U.S. Provisional Application No. 60/344,863, filed Nov. 8, 2001, and U.S. Provisional Application No. 60/355,615, filed Feb. 5, 2002.

### TECHNICAL FIELD OF THE INVENTION

The present invention relates to object detection systems, and, in particular, to a system and method for scanning carriers for objects.

### BACKGROUND OF THE INVENTION

In recent years, metal detection systems have become a commonly utilized piece of security equipment. While most people are familiar with, and accustomed to, the use of such detection systems in airports, the state of society today has unfortunately necessitated the use of walk-through metal detection systems in such unconventional locations as schools, public buildings, manufacturing facilities, and courthouses. Regardless of place of use, the primary continuing function of metal detection systems is to accurately detect the presence of illicit metallic objects, such as firearms and knives, on the body of an individual.

Unfortunately, metal detection systems, almost by definition, only detect metallic objects. Thus, there are a variety of materials that are outside the scope of detection by such systems. These materials, however, can be as destructive and/or deadly as illicit metallic objects.

### SUMMARY OF THE INVENTION

The present invention substantially reduces and/or eliminates at least some of the problems and disadvantages with the prior art. To accomplish this, the present invention provides a system and method for scanning carriers for metallic objects and radioactive objects.

In particular embodiments, a system for scanning carriers for objects includes a platform, a metal detection subsystem, a radiation detection subsystem, and a processing subsystem. The metal detection subsystem is coupled to the platform and is operable to sense a metallic object in a detection proximity of the platform and to form a signal indicative thereof. The radiation detection subsystem is also coupled to the platform and is operable to sense a radioactive object in the detection proximity of the platform and to form a signal indicative thereof. The processing subsystem is coupled to the metal detection subsystem and the radiation detection subsystem and is operable to determine, based on the signals from the metal detection subsystem and the radiation detection subsystem, if an illicit object may be in the detection proximity of the platform.

In certain embodiments, a method for scanning carriers for objects includes sensing a radioactive object in the detection proximity of a platform and forming a signal indicative thereof and determining whether an illicit radioactive object may be in the detection proximity. The method also includes sensing a metallic object in the detection proximity of the platform and forming a signal indicative thereof and determining whether an illicit metallic object may be in the detection proximity.

The present invention has a variety of technical features. For example, the invention reduces the chance that a carrier could convey radioactive material through an airport security checkpoint. Thus, the system may curtail the transport of radioactive material, which could be used to make nuclear weapons or contaminate water supplies, for example. As another example, because the system may be used to concurrently scan for radioactive objects and metallic objects, a carrier of a radioactive object would not be able to shield the radioactive object from the radiation detection subsystem by using a metallic container, most likely made of lead. Thus, conveyance of a radioactive object is made even more difficult. As a further example, in particular embodiments, a presence subsystem may detect when a carrier is in the detection proximity of the platform, allowing false alarms to be reduced, which provides for faster scanning of carriers, and allowing background calculations to be performed, which provides proper sensitivity for the detection subsystems. As another example, in certain embodiments, the inventions allow for determining a location at which an illicit object may be present. Thus, if illicit objects must be searched further, scanning time may be decreased.

Of course, some embodiments may contain none, one, some, or all of these technical features and/or additional technical features. Other technical features will be readily apparent to those skilled in the art from the following figures, detailed written description, and claims.

### BRIEF DESCRIPTION OF THE DRAWINGS

The figures described below provide a more complete understanding of the present invention and of its technical features, especially when considered in conjunction with the following detailed written description:

FIG. 1 is an illustration of a system for scanning carriers for objects in accordance with one embodiment of the present invention;

FIG. 2 is a block diagram of one embodiment of components for the system in FIG. 1;

FIG. 3 is a block diagram of one embodiment of components for the system in FIG. 1;

FIG. 4 is a flowchart illustrating a method for scanning carriers for metallic object and radioactive objects in accordance with one embodiment of the present invention;

FIG. 5 is an illustration of a system for scanning carriers for objects in accordance with another embodiment of the present invention;

FIG. 6 is a block diagram of one embodiment of components for the system of FIG. 5;

FIG. 7 is an illustration of a system for scanning carriers for objects in accordance with yet another embodiment of the present invention;

FIG. 8 is a block diagram of one embodiment of components for the system of FIG. 7;

FIG. 9 is an illustration of a system for scanning carriers for objects in accordance with still another embodiment of the present invention; and

FIG. 10 is a block diagram of one embodiment of components for the system of FIG. 9.

### DETAILED DESCRIPTION OF THE INVENTION

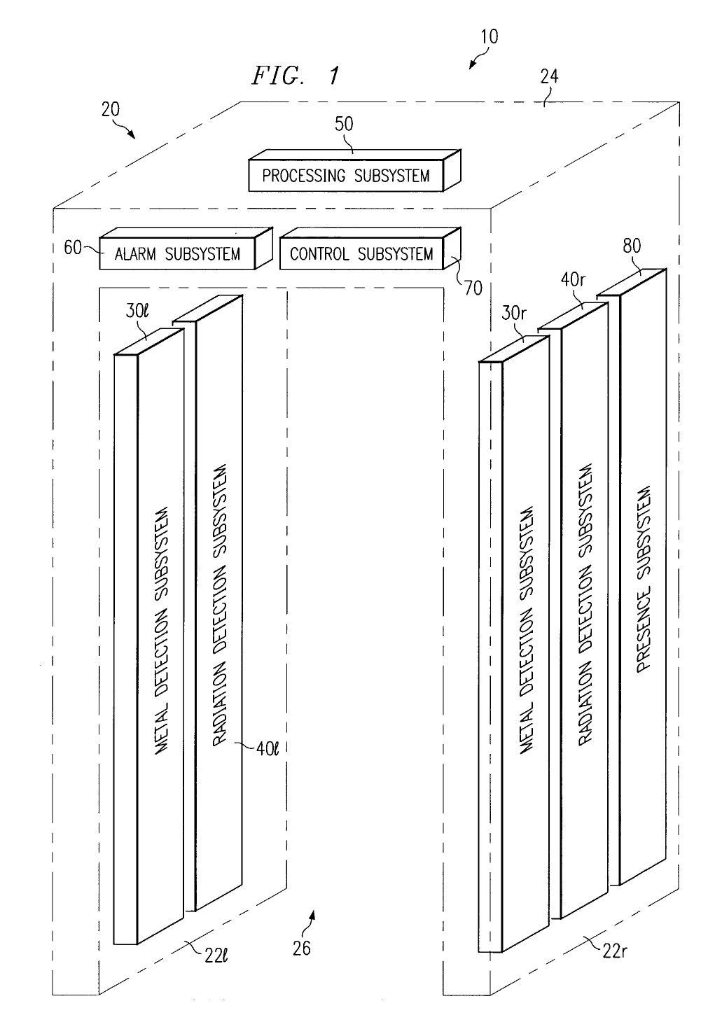

FIG. 1 is an illustration of a system 10 for scanning carriers for objects in accordance with one embodiment of the present invention. In general, system 10 includes a platform 20 and a metal detection subsystem 30, a radiation detection subsystem 40, a processing subsystem 50, and an alarm subsystem 60 supported by the platform. Metal detection subsystem 30 is operable to sense metallic objects in the detection proximity of platform 20 and to form signals indicative thereof, and radiation detection subsystem 40 is operable to sense radioactive objects in the detection proximity of platform 20 and to form signals indicative thereof. Processing subsystem 50, in turn, is operable to determine whether an illicit object may be present, and alarm subsystem 60 is operable to generate a user intelligible signal if an illicit object may be present.

In more detail, platform 20 includes a first vertical support 22l, a second vertical support 22r, and a horizontal support 24. First vertical support 22l, second vertical support 22r, and horizontal support 24 define a passage 26 through which a carrier, typically a human for this embodiment, passes for scanning for metallic objects and radioactive objects. In general, passage 26 defines the detection proximity of system 10, although the detection proximity may be somewhat smaller or larger depending on operating parameters and environments. First vertical support 22l and second vertical support 22r also house metal detection subsystem 30 and radiation detection subsystem 40, and horizontal support 24 houses processing subsystem 50 and alarm subsystem 60. First vertical support 22l, second vertical support 22r, and horizontal support 24 may have any dimension that will allow a carrier to pass through passage 26 and may be composed of plastic, composite, wood, metal, and/or any other appropriate material. In particular embodiments, platform 20 is thirty-five inches wide, eighty-seven inches tall, and twenty-nine inches deep and is composed of a wood core overlayed with a molded plastic.

Metal detection subsystem 30 includes a first portion 30l and a second portion 30r, one in each of vertical supports 22. Metal detection subsystem 30 is operable to sense a metallic object in passage 26 and to form a signal indicative thereof. Note that the signal may not completely characterize the sensed object.

In particular embodiments, metal detection subsystem 30 may include a magnetic field generator for generating a magnetic field in passage 26, a magnetic field detector for sensing disturbances in the magnetic field, and a detector circuit for detecting the disturbances in the magnetic field. A magnetic field generator could be a coil of wire coupled to an oscillator, a magnetic field detector could be a coil of wire, and a detector circuit could be a quadrature detector with inputs from the oscillator, although other types of magnetic field generators, magnetic field detectors, and detector circuits could be used. In general, metal detection subsystem 30 could be configured to operate according to any metal detection technique. For example, continuous-wave techniques usually have magnetic field generators and magnetic field detectors mounted in each of vertical supports 22 and operate in the 6-12 kilohertz (kHz) range. Pulse techniques, in contrast, usually have magnetic field generators mounted in one of vertical supports 22 and magnetic field detectors mounted in the other of vertical supports 22 and operate in the 1-50 kHz range. In other embodiments, however, metal detection subsystem 30 may utilize magnetometers. Metal detection subsystem 30 may or may not divide passage 26 into zones for metallic object detection.

Radiation detection subsystem 40 also includes a first portion 40l and a second portion 40r, one in each of vertical supports 22, for sensing a radioactive object in passage 26. Radiation detection subsystem 40 may include a scentillator, an ionizable gas, or any other appropriate type of radiation sensing device. Radiation detector subsystem 40 may be used to detect alpha particles, beta particles, gamma rays, or any other type of radioactive decay materials. Radiation detection subsystem 40 may or may not divide passage 26 into zones for radioactive object detection.

Processing subsystem 50 is coupled to metal detection subsystem 30 and radiation detection subsystem 40 and is operable to determine whether an illicit object may be present in passage 26. For example, processing subsystem 50 may receive a signal indicative of the size of an object and determine whether an illicit object may be present based on whether the signal exceeds a threshold. As another example, processing subsystem 50 may determine what type of material the sensed object is composed of and use this in determining whether an illicit object may be present. If processing subsystem 50 determines that an illicit object may be present, processing subsystem 50 may initiate an alarm by generating an appropriate signal for alarm subsystem 60. Processing subsystem 50 may be composed of digital processors, such as, for example, microprocessors, field programmable gate arrays (FPGAs), application specific integrated circuits (ASICs), state machines, and/or any of type of device for manipulating data in a logical manner, memory, such as, for example, read-only memory (ROM), compact-disk read-only memory (CD-ROM), random access memory (RAM), registers, and/or any other type of volatile or non-volatile electromagnetic or optical data storage device, communication interfaces, such as, for example, network interface cards (NICs), modems, transceivers, ports, and/or any other type of device for sending and/or receiving data, and/or analog processing devices, such as, for example, operational amplifiers, logarithmic amplifiers, filters, multiplexers, differential amplifiers, comparators, and/or any other appropriate type of analog device for manipulating signals.

Alarm subsystem 60 is coupled to processing subsystem 50 and is operable to generate a user intelligible signal if an illicit object may be in passage 26. To accomplish this, alarm subsystem 60 may generate visual and/or acoustic indications for a user. For example, alarm subsystem 60 may include a display, lights, and/or other visual device for alerting a user that an illicit object may be in passage 26. Furthermore, the visual portion may provide an indication of where the potential illicit object may be located on the carrier. For instance, a display, possibly in the shape of a grid, may indicate the zone of passage 26 in which an illicit object may be located. For the acoustic portion, alarm subsystem 60 may include a speaker, a buzzer, a siren, a bell, and/or any other acoustic device for alerting a user that an illicit object may be in passage 26. Alarm subsystem 60 may contain separate devices for metal detection subsystem 30 and radiation detection subsystem 40, or these subsystems may share devices.

System 10 also includes a control subsystem 70 in horizontal support 24. Control subsystem 70 may be used to input commands for metal detection subsystem 30, radiation detection subsystem 40, processing subsystem 50, and/or alarm subsystem 60. Control subsystem 70 may include a keypad, a touchpad, a keyboard, a voice response unit, and/or any other appropriate device for inputting data to system 10. Control subsystem 70 may also include a display to indicate the status of system 10 and/or the commands.

System 10 additionally includes a presence subsystem 80 coupled to vertical supports 22. Presence subsystem 80 is operable to detect when a carrier is in passage 26. Presence subsystem 80 may be a motion detector, a proximity detector, an interruptible laser or infrared beam, or any other type of device for detecting the presence of a carrier in passage 26. Metal detection subsystem 30, radiation detection subsystem 40, and/or processing subsystem 50 may use the data from presence subsystem 80 in performing background calculations, determining when to try to detect illicit objects, and/or determining when to produce alarms.

Metal detection subsystem 30, radiation detection subsystem 40, processing subsystem 50, alarm subsystem 60, control subsystem 70, and presence subsystem 80 may be coupled to each other by wires, fiber-optic cables, microwave channels, infrared channels, and/or any other type of wireline or wireless link.

As illustrated, system 10 has a variety of technical features. For example, system 10 reduces the chance that a carrier could convey a radioactive object through an airport security checkpoint. Thus, the system may curtail the transport of radioactive material, which could be used to make nuclear weapons or contaminate water supplies, for example. As another example, because system 10 may be used to concurrently scan for radioactive objects and metallic objects, a carrier attempting to convey a radioactive object through system 10 would not be able to shield the radioactive object from radiation detection subsystem 40 using a metallic container. Thus, attempting to convey a radioactive object through a checkpoint may be even more difficult. As a further example, because presence subsystem 80 may inform metal detection subsystem 30, radiation detection subsystem 40, and/or processing subsystem 50 when a carrier is in passage 26, the number of false alarms may be reduced, which allows for faster scanning of carriers by the system. Moreover, this allows background radiation and/or metal calculations to be performed, which may allow the sensitivity of the detection subsystems to be appropriately set. A variety of other examples exist.

Although FIG. 1 illustrates a system for scanning carriers for objects in accordance with one embodiment of the present invention, other embodiments may include fewer, more, and/or a different arrangement of components. For example, in some embodiments, a system may have a horizontal support across which carriers pass, such as, for example, a base. This support may be in addition to or to the exclusion of a horizontal support such as horizontal support 24 for system 10. As another example, the radiation detection subsystem may be located in only one vertical support of the system, in a horizontal support of the system, in the horizontal supports of the system, in the vertical and horizontal supports of the system, or at any other appropriate location. As a further example, the metal detection subsystem may be located at any appropriate location. As an additional example, the processing subsystem, the alarm subsystem, and the control subsystem may be located in one of the vertical supports, spread between the supports, or located at any other appropriate location. For instance, the alarm subsystem may include a grid on the horizontal support and LEDs on the vertical supports to help locate the metallic objects and the radioactive objects. In particular embodiments, each vertical support contains six sets of LEDs for locating a metallic object and two sets of LEDs for locating a radioactive object. Note that the LEDs for metallic objects and the LEDs for radioactive objects may have to be intermingled because the zones may overlap. In other embodiments, the processing subsystem, the alarm subsystem, and/or the control subsystem may be located remotely from the platform. As a further example, some embodiments may not include a presence subsystem. In other embodiments, the presence subsystem may be located on another or multiple supports of the system. A variety of other examples exist.

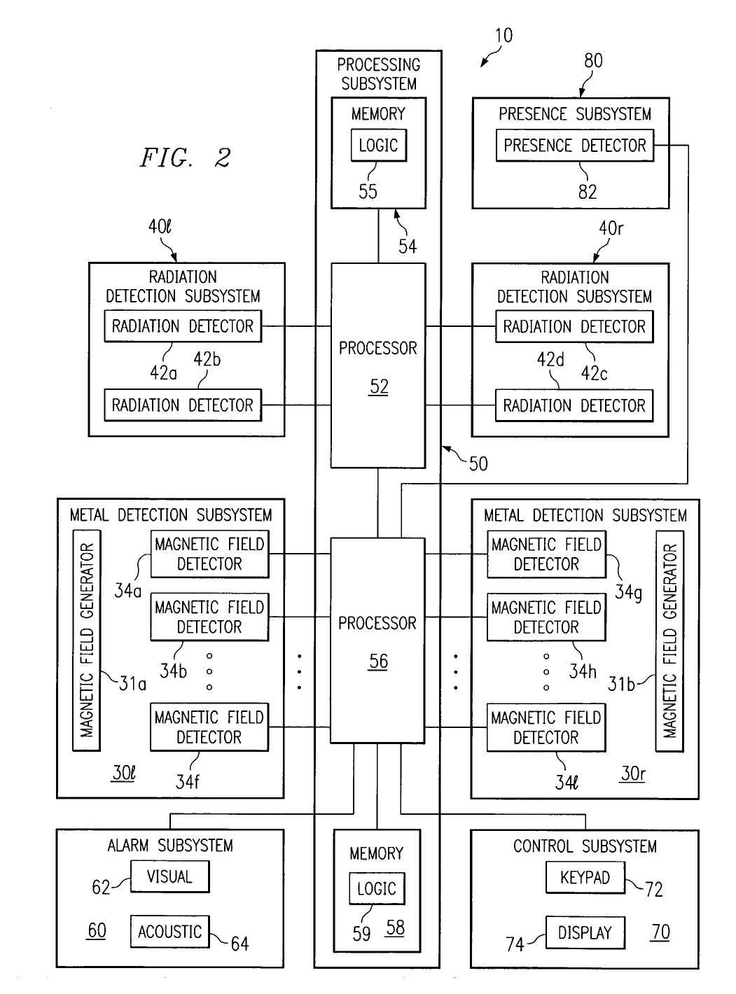

FIG. 2 is a block diagram of one embodiment of components for system 10 and their intercouplings. As illustrated in FIG. 2, system 10 is a multi-zone metallic object and radioactive object detection system.

In this embodiment, metal detection subsystem 30 includes a magnetic field generator 31a and magnetic field detectors 34a-f in first portion 301 and a magnetic field generator 31b and magnetic field detectors 34g-l in second portion 30r. Magnetic field generators 31 may be any appropriate type of device for generating a magnetic field. Magnetic field detectors 34 sense disturbances to the magnetic field generated by magnetic field generators 31 and form signals indicative thereof, each detector corresponding to a zone of the passage. Magnetic field detectors 34 may be any appropriate type of device for sensing disturbances to a magnetic field.

Coupled to each of magnetic field detectors 34 is a processor 56 in processing subsystem 50, which operates according to a set of logic 59 encoded in a memory 58. Processor 56 is operable to receive the signals, possibly after being digitized, from detectors 34 to determine if an illicit object may be in the passage and, if so, to determine in which of the zones the object is likely to be located. Processor 56 may accomplish this, for example, by taking the cube root of the signal from each detector, redundantly multiplying the rooted signals, cross differentiating the multiplied signals, determining the object metal mass in each zone, and comparing the mass in each zone to a predetermined sensitivity threshold to determine if any object has sufficient metal mass to be a potential illicit metallic object. An alarm may be initiated for each potential illicit object individually or if any object is a potential illicit object. In particular embodiments, the type of metal of which a detected object is composed may also be determined and, if desired, displayed; moreover, objects which are known not to be illicit may be filtered.

Alarm subsystem 60, in turn, includes a display portion 62 and an acoustic portion 64. Display portion 62 is operable to indicate a zone in which an illicit object may be located. To accomplish this, display portion 62 may illuminate a portion of a grid, wherein each portion corresponds to a zone, provide a textual indication of where the object may be located, or otherwise communicate a location to a user. Acoustic portion 64 is operable to generate a sound associated with a metallic object.

Also coupled to processor 56 is presence subsystem 80. Presence subsystem 80 includes a presence detector 82, which may be a photodetector for a laser beam, for example. When presence detector 82 detects that a carrier has entered the passage, possibly by the interruption of a laser beam, it signals processor 56. In particular embodiments, processor 56 may stop performing background metal detection calculations and perform metallic object detection when a carrier enters the passage.

Radiation detection subsystem 40 includes radiation detectors 42a-b in first portion 40l and radiation detectors 42c-d in second portion 40r, each detector corresponding to a zone of the passage. Note that the zones for radiation detection detectors 42 may or may not be the same as the zones for magnetic field detectors 34. Radiation detectors 42 may be any appropriate device for detecting radioactive material.

In particular embodiments, radiation detectors 42 include gamma ray sensitive scentillators manufactured by Thermo Electron Corporation. The scentillators may be powered at 1500 VAC and have a background sensitivity of 50 counts per second (cps) per Roentgen/hour (R/h), allowing them to detect a 1 Coulomb (C) Cs-137 source during a two second walk-through period. The scentillators may be optically coupled to photomultiplier tubes, to amplify the light generated thereby, and the photomultiplier tubes may be optically coupled to photodetectors, such as, for example, microbolometers or charge-coupled devices, to generate an electrical signal representative of the amplified light.

Coupled to each of radiation detectors 42 is a processor 52 in processing subsystem 50, which operates according to a set of logic 55 encoded in a memory 54. Processor 52 is operable to receive the signals, possibly after being digitized, from detectors 42, and determine if an illicit object may be present in the passage. Additionally, based on input from presence subsystem 80, if no carrier is currently in the passage, processor 52 performs background radiation calculations. Accordingly, processor 52 may continuously adjust the detection threshold based on the noise in the environment. When, however, a carrier is in the detection proximity of platform 20, processor 52 is operable to determine if an illicit object may be located in the passage and, if so, in which of the zones the object is likely to be located. For example, processor 52 may accomplish the former by comparing the signals received one second after the carrier's entrance into the passage to the signals received on second prior to the carrier's entrance into the passage and determining whether the difference exceeds a threshold. For the latter, processor 52 may compare the signals from radiation detectors 42. After making such determinations, processor 52 may send a signal to processor 56, informing it that an illicit radioactive object may be present in a particular zone. Processor 56 may then initiate the activation of an alarm by alarm subsystem 60. Alarm subsystem 60 is operable to indicate a zone in which an illicit object may be located and to generate a sound associated with a radioactive object.

Control subsystem 70 is coupled to processor 56 and includes a keypad 72 and a display 74. Keypad 72 is operable to allow a user to input commands to system 10. For example, by using keypad 72, a user may adjust the sensitivity of the metal and/or radiation detection of system 10 by instructing processor 56 and/or processor 52 to adjust a threshold or by instructing a processor to look for objects have a certain profile. Display 74 is operable to show the status of system 10 to a user.

The embodiment of system 10 illustrated by FIG. 2 has several technical features. For example, by being able to sense metallic objects on a zoned basis, lumping of metal objects together may be avoided, which may prevent false alarms due to lumping of objects from different locations together. As another example, by being able to sense radioactive objects on a zoned basis, lumping of radioactive objects together may be avoided, which may prevent false alarms due to lumping of objects from different locations together. As a further example, by being able to provide an indication of where an illicit object may be located, the screening process for carriers that have been identified as having a potential illicit object may be accelerated. As an additional example, the technical features already mentioned for system 10 in general are also available. A variety of other features exist.

Although FIG. 2 illustrates one embodiment of components for system 10, other embodiments may have fewer, more, and/or a different arrangement of components. For example, radiation detection subsystem 40 may contain any number of radiation detectors. As another example, metal detection subsystem 30 may contain any number of magnetic field generators and/or detectors. As a further example, metal detection subsystem 30 and radiation detection subsystem 40 may share a processor or be isolated. As an additional example, alarm subsystem 60 may contain either a visual portion or an acoustic portion. Furthermore, alarm subsystem 60 may use the same visual device and acoustic device for metal detection subsystem 30 and radiation detection subsystem 40. In certain embodiments, when radiation is detected, a standard yellow warning symbol is illuminated and remains illuminated until reset. The sensitivity control could be used to determine the amount of radiation present. A variety of other examples exist.

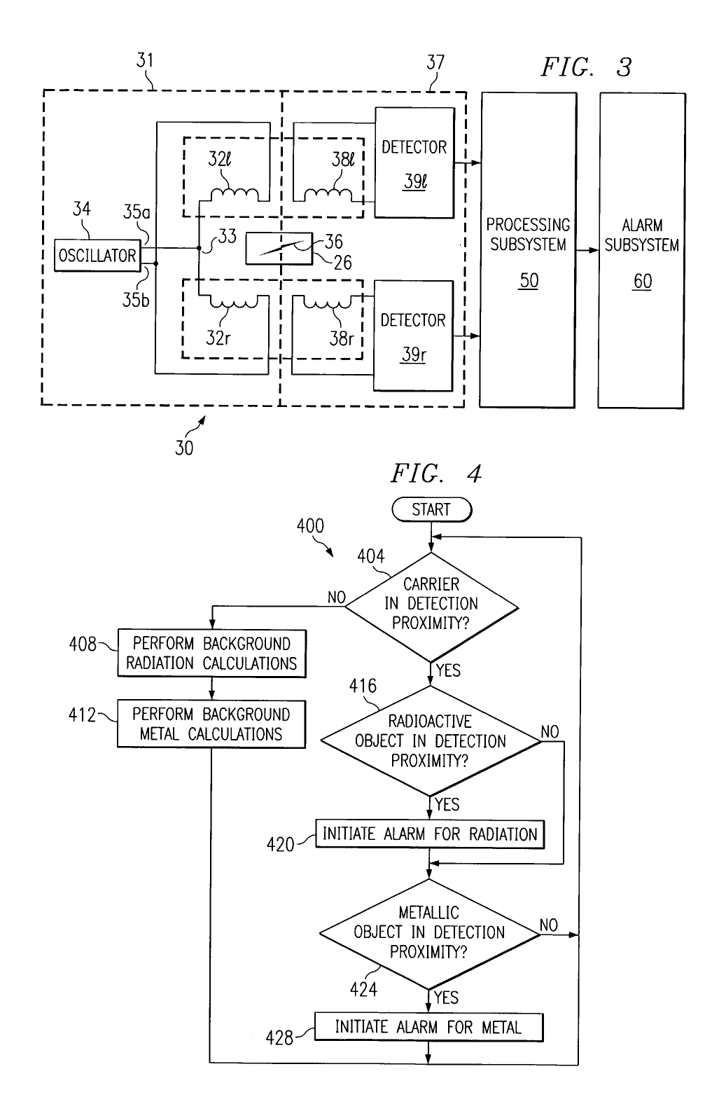

FIG. 3 is a block diagram illustrating another embodiment of components for system 10. As illustrated in this embodiment, metal detection subsystem 30 utilizes a pair of multiple turn, very low frequency coil sets positioned on either side of passage 26. One coil in each set is part of a field generation coil 32, which is connected to an oscillator 34. The single coil of wire for field generation coil 32 is split at its mid-point 33 into a right coil 32r for one coil set and a left coil 32l for the other coil set. The split coils are connected in parallel, with the mid-point 33 coupled to one alternating current port 35a of oscillator 34 and the ends connected together and to another alternating current port 35b of oscillator 34. Each coil of field generation coil 32 may contain a transmit coil, a null adjust loop, and a feedback coil connected in series, with the transmit coil shielded in a resistive Faraday split section tubular shield, the null loop coaxially aligned with the transmit coil, and the feedback coil coplanar with the transmit coil in a separate Faraday split section tubular shield. The coils of field generation coil 32 are excited in phase by oscillator 34 to generate a single alternating current electromagnetic field 36 concentrated with substantially uniform field density in passage 26.

The presence of metallic objects in passage 26 causes a disturbance in electromagnetic field 36. This disturbance is sensed by dual, right and left receive coils 38r and 38l, respectively, that, like the split transmit coil 32, are also part of the coil sets on opposite sides of passage 26. The receive coils 38 may also be co-planar and coaxially aligned with the transmit coils and co-located with a null adjust and feedback coil, such that the sensitivity of system 10 near the ends of the coil structure is enhanced. Each receive coil 38 in a coil set is connected to a corresponding detector circuit 39 that detects the magnetic field disturbance. As mentioned previously, detector circuits 39 may include baluns, filters, amplifiers, quadrature detectors, and/or any other type of device for processing an electrical signal.

The outputs from detector circuits 39 are sent to processing subsystem 50, which may take the cube roots of the signals from detector circuits 39, redundantly multiply and cross-differentiate the cube roots, select the lesser result (weaker signal) as an approximation of the total mass of the metal object(s) detected in passage 26, and initiate the activation of an alarm by alarm subsystem 60 if the determined metal mass exceeds a predetermined threshold mass level.

Although FIG. 3 illustrates one embodiment of components for system 10, other embodiments may include fewer, additional, and/or a different arrangement of components. For example, in particular embodiments, subsystem 30 may include a fairly large number of receiving coils and detector circuit pairs, each pair assigned to a zone of passage 26. Thus, by comparing the signals from the detector circuits, the processing subsystem may be able to provide an indication of where an illicit object may be located. As another example, in some embodiments, the magnetic field generators may be on one side and the magnetic field detectors may be on the other side of passage 26. As a further example, the field generation coils do not have to connected to the same oscillator. A variety of other examples exist.

FIG. 4 is a flowchart 400 of a method for scanning carriers for objects in accordance with one embodiment of the present invention. The method begins at decision block 404 with determining whether a carrier is in the detection proximity of a system for scanning carriers for objects. As mentioned previously, this may be accomplished, for example, by analyzing signals from a motion sensing device, a proximity sensing device, or an interruptible laser or IR beam.

If a carrier is not in the detection proximity of the system, the method calls for performing background radiation calculations at function block 408 and for performing background metal calculations at function block 412. As mentioned previously, these calculations may be used in the future for determining whether an illicit object may be present.

If, however, a carrier is in the detection proximity of the system, the method calls for determining whether a radioactive object may be in the detection proximity of the system at decision block 416. This may be accomplished, for example, by determining whether radiation in the detection proximity of the system exceeds a threshold. The amount of radiation in the detection proximity of the system may be determined from a signal indicative of radiation in the detection proximity of the system, which could be from a radiation detector similar to radiation detector 42a, for example, and the threshold may be fixed, vary depending on the type of radiation detected, and/or be updated based on the background radiation calculations. If a radioactive object may be present, the method calls for initiating an alarm for radiation at function block 420. Initiating an alarm may involve generating an appropriate signal for an alarm subsystem such as alarm subsystem 60.

At decision block 424, the method calls for determining whether a metallic object may be in the detection proximity of the system. This may be accomplished, for example, by determining whether the amount of metal in the detection proximity of the system exceeds a threshold. The amount of metal in the detection proximity of the system may be determined from a signal indicative of metal in the detection proximity of the system, which could be from a magnetic field detector similar to magnetic field detector 34a, for example, and the threshold could be fixed, vary depending upon the type of metal detected, and/or updated based upon the background metal calculations. If a metallic object may be present, the method calls for initiating an alarm for metal at function block 428. Initiating an alarm may involve generating an appropriate signal for an alarm subsystem. The method then returns to decision block 404.

Although flowchart 400 illustrates a method for scanning carriers for objects in accordance with one embodiment of the present invention, other embodiments may contain fewer, more, and/or a different arrangement of operations. For example, some embodiments may not call for determining whether a carrier is in the detection proximity of the system. As another example, particular embodiments may not call for performing background radiation and/or metal calculations. As an additional example, in some embodiments, determining whether a metallic object may be present may be performed before determining whether a radioactive object may be present. Moreover, in other embodiments, the two determinations may be performed concurrently. As a further example, in certain embodiments, if a radioactive object and/or a metallic object is detected during background calculations, an alarm may generated. As an additional example, in some embodiments, the zone in which an illicit object may be located may be determined. As another example, after function block 428 has been completed, a signal may be generated to instruct a carrier to enter the detection proximity of the system for scanning. A variety of other examples exist.

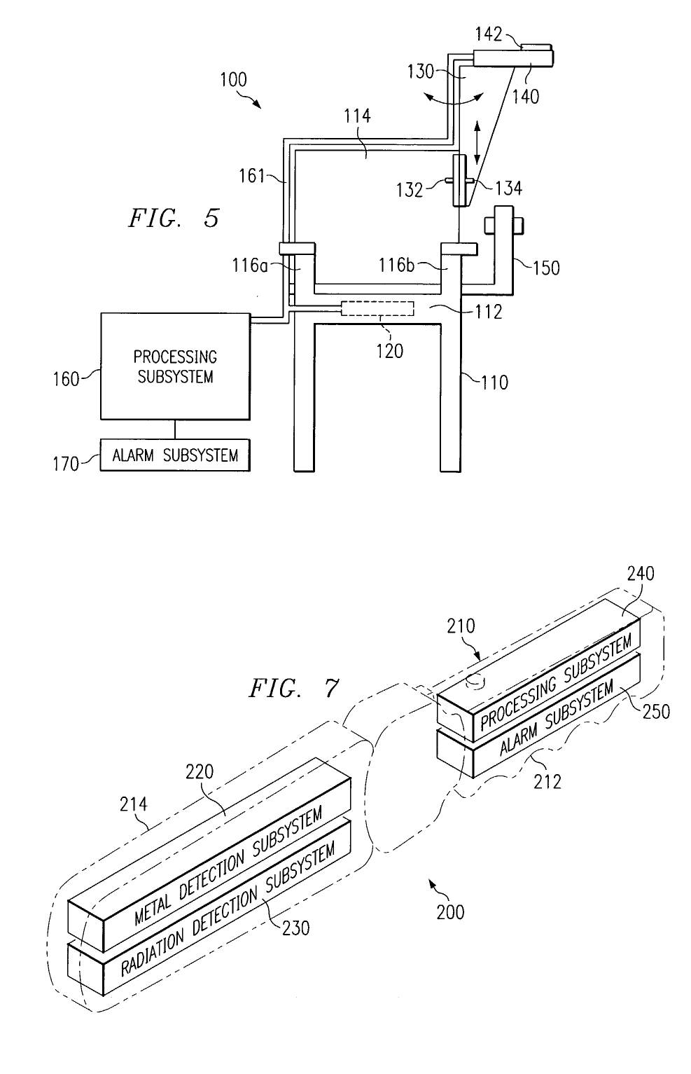

FIG. 5 is an illustration of a system 100 for scanning carriers for objects in accordance with another embodiment of the present invention. As illustrated, system 100 is a user support structure having metal detection and radiation detection capabilities.

In more detail, system 100 includes a platform 110 having a horizontal user support portion 112, a vertical user support portion 114, and peripheral user support portions 116. In general, platform 110 is configured to allow a human to sit thereon. Platform 110 may be composed of plastic, wood, composite, metal, and/or any other appropriate material and may have any appropriate dimension.

Mounted underneath horizontal user support portion 112 is a metal detection subsystem 120, which may be similar to metal detection subsystem 30 of system 10. Metal detection subsystem 120 is operable to detect metallic objects in a localized area of the detection proximity of platform 110. Due to its location, subsystem 120 senses metal objects located in the anal/vagina (a/v) region of a carrier being scanned.

System 100 also includes a support platform 130 extending from platform 110. Support platform 130 includes a vertical adjuster 132 and a rotational adjuster 134. Vertical adjuster 132 permits an upward or downward movement of the support platform 130 in relation to platform 110. A desirable height of support platform 130 depends on the height of the carrier being scanned. Rotational adjuster 134 permits support platform 130 to be rotated inward or outward from platform 110.

A second metal detection subsystem 140 is coupled —rigidly, rotatably or otherwise—to support platform 130. Second metal detection subsystem 140 is also operable to detect metallic objects in a localized area of the detection proximity of platform 110. As such, second metal detection subsystem 140 is used to scan for metallic objects in the oral/facial (o/f) region of a carrier. Second metal detection subsystem 140 may further include a chin rest 142 to properly locate the o/f region of the carrier in order to maximize the detection capabilities of the system 100.

System 100 additionally includes a radiation detection subsystem 150. Radiation detection subsystem 150 may be similar to radiation detection subsystem 40 of system 10 and, as shown, is located to sense radiation from a carrier being scanned in or adjacent to platform 110.

Metal detection subsystem 120, second metal detection subsystem 140, and radiation detection subsystem 150 are electrically coupled via cables located in a raceway 161 to a control subsystem 160. Control subsystem 160 contains electronic components for receiving detection signals for the subsystems, determining whether an illicit object may be present, and initiating an alarm if an illicit object may be present.

System 100 also includes an alarm subsystem 170. Alarm subsystem 170 is coupled to processing subsystem 160 and is operable to generate visual and/or acoustic signals for metal detection subsystem 120, metal detection subsystem 140, and radiation detection subsystem 150.

System 100 has a variety of technical features. For example, by having metal detection subsystems positioned for specific locations of a carrier, lower strength magnetic fields may be used, which may be less detrimental to the carrier. Additionally, by being able to scan for metallic objects and radioactive objects, the system prevents carriers from hiding radioactive objects with metallic objects. A variety of other features exist.

Although FIG. 5 illustrates one embodiment of a system for scanning carriers for metallic objects and radioactive objects, other embodiments may include fewer, more, and/or a different arrangement of components. For example, in some embodiments, metal detection subsystem 120 may be located on or within horizontal user support portion 112 of platform 110, behind, on, or in vertical user support portion 114 of platform 110, or at any other location of platform 110. In general, therefore, metal detection subsystem 120 may be located anywhere where it can scan the appropriate portion of a carrier. Moreover, some embodiments may include several metal detection subsystems distributed throughout platform 110. Additionally, radiation detection subsystem 150 may be located at any position at which it can effectively scan a carrier for radioactive objects. As a further example, some embodiments may not include metal detection subsystem 120 and/or metal detection subsystem 140. As another example, platform 110 is only one example of a user support device that could incorporate a metal detection system and radiation detection system. A variety of other examples exist.

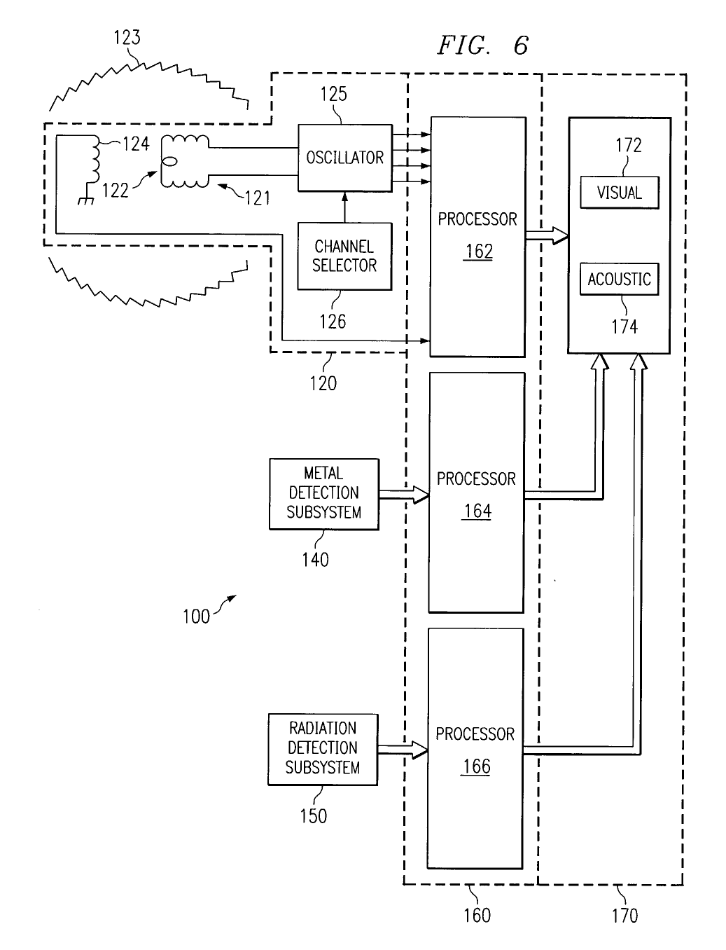

FIG. 6 provides a block diagram of one embodiment of metal detection subsystem 120, metal detection subsystem 140, radiation detection subsystem 150, processing subsystem 160, and alarm subsystem 170 for system 100.

In this embodiment, metal detection subsystem 120, which is representative of metal detection subsystem 140, includes a detector coil set 121, an oscillator 125, and a channel selector 126. Detector coil set 121 includes a multiple turn coil 122 having one end coupled to an alternating current port of oscillator 125 and another end coupled to another alternating current port of oscillator 125. Coil 122 is positioned near the area of the carrier to be scanned and generates a magnetic field 123 when excited by oscillator 125. By exciting coil 122 in phase, a concentrated, single alternating current electromagnetic field with substantially uniform field density around and through the carrier being scanned may be generated. Detector coil set 121 also includes a multiple turn coil 124 for sensing disturbances to magnetic field 123, which are caused by metal objects on and/or in the carrier. The disturbances manifest themselves as electrical signals, which are analyzed to determine whether a potential illicit object may be present.

Oscillator 125 is also coupled to channel selector circuit 126, which enables metal detection subsystem 120 to operate at different frequencies for the generated alternating current electromagnetic field 123. In particular embodiments, the frequencies are centered around 6 kHz, with 100 Hz separating the available channels. Slight phase adjustments in the generated alternating current signal may also be possible with selector circuit 126. With proper frequency and phase selection, multiple metal detection subsystems, such as metal detection subsystem 120 and metal detection subsystem 140, may be operated in close proximity to each other with minimal interference.

Processing subsystem 160 includes a processor 162, a processor 164, and a processor 166. Processor 162, processor 164, and processor 166 are coupled to metal detection subsystem 120, metal detection subsystem 140, and radiation detection subsystem 150, respectively. The processors are responsible for receiving the signals formed by the subsystems and determining whether an illicit object may be present. If so, an appropriate alarm is initiated by signaling alarm subsystem 170. Note that processor 162 and processor 164 may have different sensitivities for their respective metal detection subsystems.

In certain embodiments, processing subsystem 160 may contain control devices, such as knobs, switches, dials, or other appropriate devices. The control devices could include a power switch to turn on or off system 100. Metal detection system 100 is typically connected to a conventional 120VAC power source that is transformed into whatever voltage is required by the various electronic components. The control devices could also include sensitivity adjustments for the detection subsystems. Processing subsystem 160 may also include a light to indicate when system 100 is on.

Alarm subsystem 170 includes a visual portion 172 and an acoustic portion 174. Visual portion 172 includes an a/v region indicator, an o/f region indicator, and a radiation indicator. The a/v region indicator is actuated upon detection of a metallic object in the a/v region of the carrier being scanned, the o/f indicator is actuated upon detection of a metallic object in the o/f region of the carrier being scanned, and the radiation indicator is actuated upon detection of a radioactive object on the carrier being scanned. Acoustic portion 174 is actuated upon detection of a potential illicit object by any of metal detection subsystem 120, metal detection subsystem 140, and radiation detection subsystem 150.

Although FIG. 6 illustrates one embodiment of metal detection subsystem 120, metal detection subsystem 140, radiation detection subsystem 150, processing subsystem 160, and alarm subsystem 170 for system 100, other embodiments may contain fewer, more, and/or a different arrangement of components. For example, some embodiments may not include metal detection subsystem 120 and/or metal detection subsystem 140. As another example, certain embodiments may have additional metal detector subsystems, such as, for example, for the torso or legs of a carrier. As an additional example, alarm subsystem 170 may provide an indication of the type of metallic object or radioactive object detected and/or of the size. As a further example, alarm subsystem 170 may share alarms between detection subsystems. As another example, the detection subsystems may share a processor or the processors may be coupled to each other. As a further example, in some embodiments, the detection subsystems may include detector circuits. A variety of other examples exist.

FIG. 7 is an illustration of a system 200 for scanning carriers for objects in accordance with yet another embodiment of the present invention. As illustrated, system 200 is a hand-held metal/radiation detection system. System 200 is typically associated with a walk-through metal/radiation detector such as system 10, although it need to be.

In more detail, system 200 includes a platform 210, a metal detection subsystem 220, a radiation detection subsystem 230, a processing subsystem 240, and an alarm subsystem 250. Platform 210 includes a handle section 212 and a scanning section 214. Handle section 212 is configured for grasp by the human hand. Scanning section 214 is configured to allow metal detection and radiation detection scanning in the detection proximity of the platform, typically between about zero to twelve inches from the platform. Platform 210 may be composed of plastic, composite, wood, metal, and/or any other appropriate material and may have any appropriate dimension. Metal detection subsystem 220 and radiation detection subsystem 230, in general, may be any appropriate components for scanning for metallic objects and radioactive objects. Processing subsystem 240 is operable to analyze the signals formed by the detection subsystems to determine whether an illicit object may be present, and alarm subsystem 250 is operable to generate a user intelligible signal, visual and/or acoustic, if an illicit object may be present.

System 200 has a variety of technical features. For example, being able to scan for metallic objects and radioactive objects with a hand-held system may allow a finer resolution scan to be conducted on carriers that may have illicit objects. Additionally, a hand-held system may allow for scanning of individuals who cannot or do not pass through a walk-through system. Moreover, a hand-held system provides the ability to readily relocate to where potential carriers may be located. A variety of other technical features exist.

Although system 200 illustrates a system for scanning carriers for objects in accordance with one embodiment of the present invention, other embodiments may include fewer, more, and/or a different arrangement of components. In particular embodiments, a hand-held system may include a sensitivity control, which is adjustable by an operator to set the threshold of radiation alarm or to determine the level of radiation present. In some embodiments, when radiation is detected, a standard yellow warning symbol is illuminated and remains illuminated until reset from the sensitivity control. In certain embodiments, the system includes a presence subsystem coupled to the platform, the subsystem operable to determine when a carrier is in the detection proximity of the platform. The processing subsystem may perform background radiation calculations when the presence subsystem does not detect a carrier in the detection proximity of the platform and perform radioactive object detection calculations when the presence subsystem detects a carrier in the detection proximity of the platform. In other embodiments, handle section 212 includes a switch to notify processing subsystem 240 when scanning is to occur. This may allow system 200 to adjust for background noise. In certain embodiments, platform 210 does not include handle 212. In particular embodiments, the processing subsystem and/or the alarm subsystem may be located remotely from the platform. A variety of other examples exist.

In certain embodiments, a hand-held system such as system 200 could be coupled to a walk-through detector such as system 10. By being so coupled, the hand-held system may receive power and/or data from the walkthrough system. For example, the hand-held system may have its sensitivity adjusted based upon sensitivity of the walk-through system. Additionally, the hand-held system may send data for processing or data regarding detections of potential illicit objects to the walkthrough system. The hand-held system may be coupled to the walk-through system by a wire, a fiber-optic cable, a microwave channel, an infrared channel, or any other appropriate wireline or wireless link.

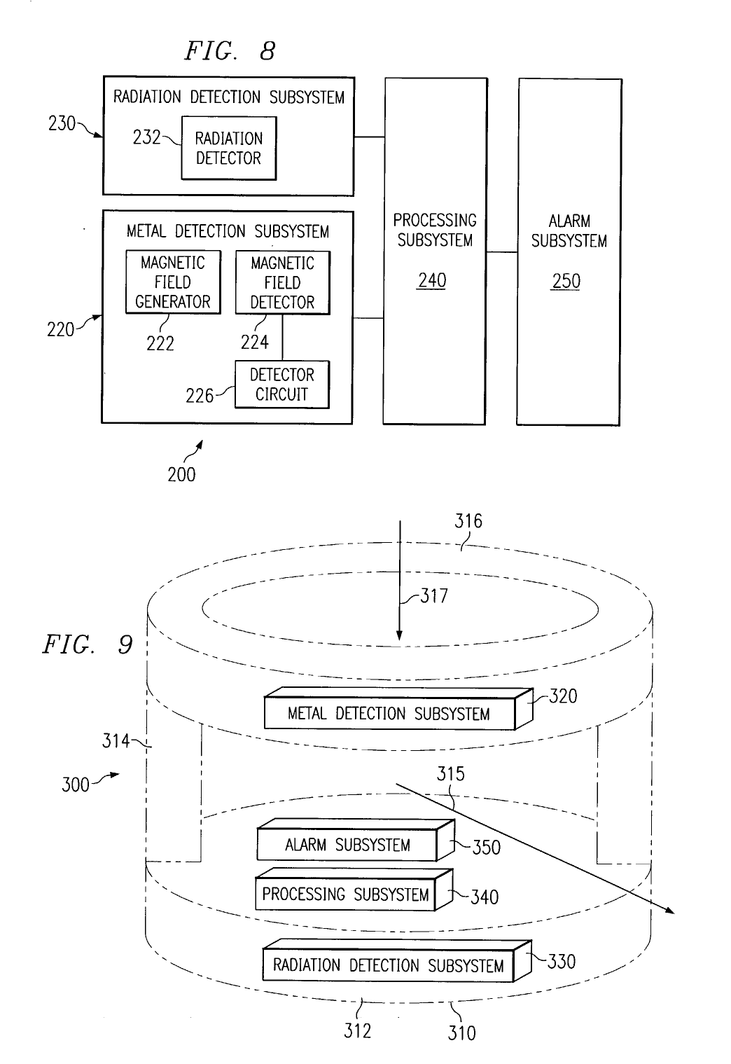

FIG. 8 is a block diagram of one embodiment of metal detection subsystem 220, radiation detection subsystem 230, processing subsystem 240, and alarm subsystem 250 for system 200.

In this embodiment, metal detection subsystem 220 includes a magnetic field generator 222, a magnetic field detector 224, and a detector circuit 226. Magnetic field generator 222 generates a magnetic field that is disturbed by the presence of a metal object in the detection proximity of system 200. Magnetic field generator may be an oscillator coupled to a coil of wire, for example. Magnetic field detector 224 is located at an effective distance to sense disturbances to the magnetic field generated by magnetic field generator 222. Magnetic field detector 224 may be a coil of wire, for example. Detector circuit 226 is coupled to magnetic field detector 224 and is operable to detect signals generated by magnetic field detector 224, the signals representing disturbances to the magnetic field. Detector circuit 226 may include a balun, an amplifier, a detector, a low-pass filter, and a quadrature detector, for example.

Radiation detection subsystem 230 includes a radiation detector 232. Radiation detector 232 may be include a scentillator, an ionizable gas, or any other appropriate device for sensing radiation. Radiation detector 232 may sense any appropriate type of radiation, such as, for example, alpha particles, beta particles, or gamma rays.

Processing subsystem 240 is coupled to metal detection subsystem 220 and radiation detection subsystem 230 and is operable to determine whether an illicit object may be present in the detection proximity of system 200. For example, processing subsystem 240 may receive a signal indicative of the size of an object and determine whether the object is potentially illicit based on whether the signal exceeds a threshold. As another example, processing subsystem 240 may determine the type of material of which the object is composed and use this in determining whether the object is potentially illicit. If processing subsystem 240 determines that an object is potentially illicit, it may initiate an alarm by alarm subsystem 250. Processing subsystem 240 may be composed of digital processors, such as, for example, microprocessors, FPGAs, ASICs, state machines, or any of type of device for manipulating data in a logical manner, memory, such as, for example, ROM, CD-ROM, RAM, registers, or any other type of volatile or non-volatile electromagnetic or optical data storage device, communication interfaces, such as, for example, NICs, modems, transceivers, ports, or any other type of device for sending and/or receiving data, and/or analog processors. Processing subsystem 240 may have a processor for each of metal detection subsystem 220 and radiation detection subsystem 230, or the subsystems may share a processor.

Alarm subsystem 250 is coupled to processing subsystem 240 and generates user intelligible signals if an illicit object may be present. Alarm subsystem 250 may have a visual portion, a display, a gauge (analog or digital), an LED readout, and/or any other appropriate type of visual device, an acoustic portion which could include a speaker, a buzzer, a bell, or a siren, and/or any other appropriate type of acoustic device, or a combination thereof. In particular embodiments, alarm subsystem 250 includes an audible alarm for metal detection and an LED read-out for radiation detection. Thus, alarm subsystem 250 may generate different outputs depending upon the type of object that was detected. Additionally, alarm subsystem 250 may provide an indication of the size of the object detected.

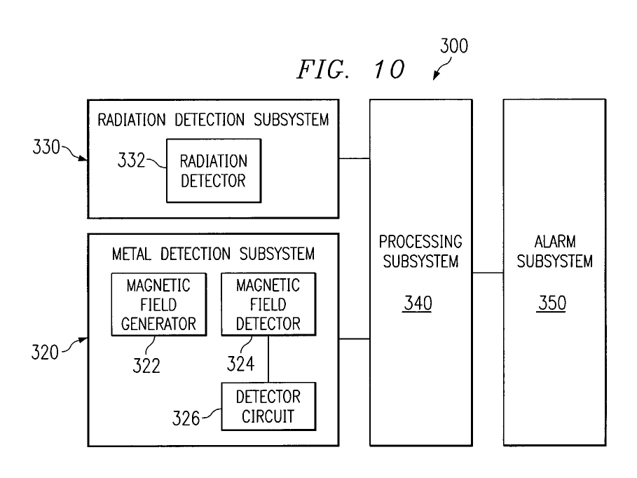

FIG. 9 is an illustration of a system 300 for scanning carriers for objects in accordance with still another embodiment of the present invention. As illustrated, system 300 is a pass-through detector, whhich may be particularly useful for scanning carriers such as mail bags or parcels, although any of a variety of other carriers could be scanned.

In more detail, system 300 includes a platform 310, a metal detection subsystem 320, a radiation detection subsystem 330, a processing subsystem 340, and an alarm subsystem 350. Platform 310 includes a base portion 312, a vertical support portion 314, and a horizontal support portion 316, which are all generally circular in shape, although they need not be. To pass the carrier for scanning, horizontal support portion 316 contains an aperture 317, and vertical support portion 314 contains an aperture 315. Platform 310 may be composed of plastic, composite, wood, metal, and/or any other appropriate material. Metal detection subsystem 320 is located in ring portion 316 so that a carrier is scanned for metallic objects as it passes through aperture 319. Radiation detection subsystem 330 is located in base portion 312 so that the carrier is scanned for radiation while inside platform 310. Metal detection subsystem 320 and radiation detection subsystem 330, in general, may be any appropriate component for scanning for metallic objects and radioactive objects. Processing subsystem 340 is operable to analyze the signals formed by the detection subsystems to determine whether an illicit object may be present, and alarm subsystem 350 is operable to generate a user intelligible signal, visual and/or acoustic, if an illicit object may be present.

Although FIG. 9 illustrates one embodiment of a pass-through metal/radiation detector, other embodiments may have fewer, more, and/or a different arrangement of components. For example, metal detection subsystem 320 may be located in vertical support 314, located in base portion 312, or distributed between the portions of platform 310. As another example, radiation detection subsystem 330 may be located at any appropriate position in platform 310. As a further example, processing subsystem 340 and/or alarm subsystem 350 may be located at any appropriate location on and/or remotely from platform 310. As an additional example, system 300 may include a presence subsystem. A variety of other examples exist.

FIG. 10 is a block diagram of one embodiment of metal detection subsystem 320, radiation detection subsystem 330, processing subsystem 340, and alarm subsystem 350 for system 300.

In this embodiment, metal detection subsystem 320 includes a magnetic field generator 322, a magnetic field detector 324, and a detector circuit 326. Magnetic field generator 322 generates a magnetic field for detection of metallic objects, and may be an oscillator coupled to a coil of wire that encircles horizontal support 316, for example. Magnetic field detector 224 senses disturbances to the magnetic field generated by magnetic field generator 324 and generates electrical signals indicative of the disturbances thereto. Magnetic field detector 324 may be a coil of wire that encircles horizontal support 316, for example. Detector circuit 326 is coupled to magnetic field detector 324 and is operable to detect signals generated by magnetic field detector 324, the signals representing disturbances to the magnetic field. Detector circuit 326 may include a balun, an amplifier, a detector, and a low-pass filter, and a quadrature detector, for example.

Radiation detection subsystem 330 includes a radiation detector 332. Radiation detector 332 may be a scentillator, an ionizable gas, or any other appropriate device for sensing radiation. Radiation detector 332 may sense any appropriate type of radiation, such as, for example, alpha particles, beta particles, or gamma rays.

Processing subsystem 340 is coupled to metal detection subsystem 320 and radiation detection subsystem 330 and is operable to determine whether an illicit object may be passing through platform 310. For example, processing subsystem 340 may receive a signal indicative of the size of an object and determine whether the object is potentially illicit based on whether the signal exceeds a threshold. As another example, processing subsystem 340 may determine the type of material of which the object is composed and use this in determining whether the object is potentially illicit. If processing subsystem 340 determines that an illicit object may be present, it may initiate an alarm by alarm subsystem 350. Processing subsystem 340 may be composed of digital processors, such as, for example, microprocessors, FPGAs, ASICs, state machines, or any of type of device for manipulating data in a logical manner, memory, such as, for example, ROM, CD-ROM, RAM, registers, or any other type of volatile or non-volatile electromagnetic or optical data storage device, communication interfaces, such as, for example, NICs, modems, transceivers, ports, or any other type of device for sending and/or receiving data, and/or analog processors. Processing subsystem 340 may have a processor for each of metal detection subsystem 320 and radiation detection subsystem 330, or the subsystems may share a processor.

Alarm subsystem 350 is coupled to processing subsystem 340 and generates user intelligible signals if an illicit object may be present. Alarm subsystem 350 may have a visual portion, which could include a display, a gauge (analog or digital), or an LED readout, and/or any other appropriate visual device, an acoustic portion, which could include a speaker, a buzzer, a bell, or a siren, and/or any other appropriate acoustic device, or a combination thereof. In particular embodiments, alarm subsystem 350 includes an audible alarm for metal detection and an LED read-out for radiation detection. Thus, alarm subsystem 350 may generate different outputs depending upon the type of object that was detected. Additionally, alarm subsystem 350 may provide an indication of the size of the object detected.

Although system 300 illustrates a system for scanning carriers for objects in accordance with one embodiment of the present invention, other embodiments may include fewer, more, and/or a different arrangement of components. For example, in particular embodiments, a system may include a sensitivity control that is adjustable by an operator to set the threshold of radiation alarm or to determine the level of radiation present. In certain embodiments, when radiation is detected, a standard yellow warning symbol is illuminated and remains illuminated until reset from the sensitivity control.

The present invention has been discussed with respect to a variety of platforms. It should be recognized, however, that the invention is applicable to any type of platform. Moreover, the invention is applicable to scanning any type of object that could be carrying a metallic and/or radioactive object.

Furthermore, while the present invention has been described with a variety of embodiments, the invention is not intended to be measured thereby, but by the claims that follow. Moreover, a variety of additions, deletions, substitutions, and transformations of the discussed and illustrated embodiments will be readily suggested to those skilled in the art. It is intended therefore that the following claims encompass such additions, deletions, substitutions, and transformations to the extent that they do not do violence to the spirit of the claims.

What is claimed is:

1. A system for scanning carriers for objects, comprising:
a platform;
a metal detection subsystem coupled to the platform, the metal detection subsystem operable to sense a metallic object in a detection proximity of the platform and to form a signal indicative thereof;
a radiation detection subsystem coupled to the platform, the radiation detection subsystem operable to sense a radioactive object in the detection proximity of the platform and to form a signal indicative thereof; and
a processing subsystem coupled to the metal detection subsystem and the radiation detection subsystem, the processing subsystem operable to determine, based on the signals from the metal detection subsystem and the radiation detection subsystem, if an illicit object may be in the detection proximity of the platform.

2. The system of claim 1, wherein the platform includes a walk-through passage.

3. The system of claim 1, wherein the platform comprises a housing.

4. The system of claim 1, wherein the radiation detection subsystem comprises:
a scentillator operable to sense the presence of a radioactive object and to generate a light signal indicative thereof;
a photomultiplier tube operable to amplify the light signal; and
a photodetector operable to detect the amplified light signal and to generate an electrical signal indicative thereof.

5. The system of claim 1, wherein the scentillator senses gamma rays to sense the presence of a radioactive object.

6. The system of claim 1, wherein:
the radiation detection subsystem comprises a plurality of radiation detectors, each detector corresponding to a different zone of the platform; and
the processing subsystem is operable to determine the zone in which a radioactive object is likely to be located.

7. The system of claim 1, wherein the metal detection subsystem comprises:
a magnetic field generator; and
a magnetic field detector.

8. The system of claim 7, wherein:
the magnetic field generator comprises:
an oscillator, and
a coil of wire coupled to the oscillator, the coil generating a magnetic field when excited by the oscillator; and
the magnetic field detector comprises:
a coil of wire operable to generate an electrical signal if the magnetic field is disturbed, and
a detector circuit coupled to the coil of wire, the detector circuit operable to detect the electrical signal.

9. The system of claim 1, wherein:
the metal detection subsystem comprises a plurality of magnetic field detectors, each detector corresponding to a different zone of the platform; and
the processing subsystem is operable to determine the zone in which a metallic object is likely to be located.

10. The system of claim 1, further comprising a presence subsystem coupled to the processing subsystem, the presence subsystem operable to determine when a carrier is in the detection proximity of the platform.

11. The system of claim 10, wherein the processing subsystem is operable to:
perform background radiation calculations when the presence subsystem does not detect a carrier in the detection proximity of the platform; and
perform radioactive object detection calculations when the presence subsystem detects a carrier in the detection proximity of the platform.

12. The system of claim 10, wherein the processing subsystem continues to perform metallic object detection calculations when the presence subsystem does not detect a carrier is in the detection proximity of the platform, but does not initiate an alarm if an illicit metallic object may be in the detection proximity of the platform.

13. The system of claim 1, further comprising an alarm subsystem coupled to the processing subsystem, the alarm subsystem operable to generate a user intelligible signal if an illicit object may be in the detection proximity of the platform.

14. The system of claim 13, wherein the alarm subsystem comprises a visual portion operable to alert a user if an illicit object may be in the detection proximity of the platform.

15. The system of claim 14, wherein the visual portion provides an indication of where an illicit object may be located on a carrier.

16. The system of claim 15, wherein the indication is different for metallic objects and radioactive objects.

17. The system of claim 13, wherein the alarm subsystem comprises an acoustic portion operable to alert a user if an illicit object may be in the detection proximity of the platform.

18. The system of claim 17, wherein the acoustic portion outputs a first sound if an illicit metallic object may be present and a second sound if an illicit radioactive object may be present.

19. They system of claim 1, further comprising a second metal detection subsystem coupled to the platform, the second metal detection subsystem operable to scan a portion of a carrier for metallic objects.

20. The system of claim 19, wherein the portion comprises the oral/facial region of a carrier.

21. A method for scanning carriers for objects, comprising:
sensing a radioactive object in the detection proximity of a platform and forming a signal indicative thereof;
determining whether an illicit radioactive object may be in the detection proximity;
sensing a metallic object in the detection proximity of the platform and forming a signal indicative thereof; and
determining whether an illicit metallic object may be in the detection proximity.

22. The method of claim 21, wherein the platform includes a walk-through passage.

23. The method of claim 21, wherein determining whether an illicit radioactive object may be in the detection proximity comprises determining whether the signal exceeds a threshold.

24. The method of claim 23, wherein determining whether the signal exceeds a threshold comprises comparing the radiation in the detection proximity of the platform to the background radiation in the detection proximity of the platform.

25. The method of claim 21, wherein:
sensing a radioactive object in the detection proximity of the platform and forming a signal indicative thereof comprises sensing a radioactive object in a plurality of zones of the platform and forming signals indicative thereof, each signal associated with a different zone of the platform; and
determining whether an illicit radioactive object may be in the detection proximity comprises determining whether any of the signals exceeds a threshold and, if so, determining the zone in which the object is likely to be located.

26. The method of claim 21, wherein:
sensing a metallic object in the detection proximity of the platform and forming a signal indicative thereof comprises sensing a metallic object in a plurality of zones of the platform and forming signals indicative thereof, each signal associated with a different zone of the platform; and
determining whether an illicit metallic object may be in the detection proximity comprises determining whether any of the signals exceed a threshold and, if so, determining the zone in which the object is likely to be located.

27. The method of claim 21, further comprising:
determining whether a carrier is in the detection proximity of the platform; and
performing background radiation calculations if a carrier is not in the detection proximity of the platform.

28. The method of claim 27, further comprising refusing to initiate an alarm for an illicit metallic object if a carrier is not in the detection proximity of the platform.

29. The method of claim 27, further comprising generating a signal to inform a carrier to proceed with scanning if scanning of a carrier is complete.

30. The method of claim 21, further comprising generating a user intelligible signal if an illicit object may be in the detection proximity of the platform.

31. A set of logic for scanning carriers for objects, the logic encoded in a computer readable medium and operable to:
receive a signal indicative of a radioactive object in the detection proximity of a platform;
determine whether an illicit radioactive object may be in the detection proximity;
receive a signal indicative of a metallic object in the detection proximity of the platform; and
determine whether an illicit metallic object may be in the detection proximity.

32. The logic of claim 31, wherein the platform includes a walk-through passage.

33. The logic of claim 31, wherein determining whether an illicit radioactive object may be in the detection proximity comprises determining whether the signal exceeds a threshold.

34. The logic of claim 33, wherein determining whether the signal exceeds a threshold comprises comparing the radiation in the detection proximity of the platform to the background radiation in the detection proximity of the platform.

35. The logic of claim 31, wherein:
receiving a signal indicative of a radioactive object in the detection proximity of a platform comprises receiving a plurality of signals indicative of a radioactive object in the detection proximity of the platform, each signal associated with a different zone of the platform; and
determining whether an illicit radioactive object may be in the detection proximity comprises determining whether any of the signals exceeds a threshold and, if so, determining the zone in which the object is likely to be located.

36. The logic of claim 31, wherein:
receiving a signal indicative of a metallic object in the detection proximity of the platform comprises receiving a plurality of signals indicative of a metallic object in the detection proximity of the platform; and
determining whether an illicit metallic object may be in the detection proximity comprises determining whether any of the signals exceeds a threshold and, if so, determining the zone in which the object is likely to be located.

37. The logic of claim 31, wherein the logic is further operable to:
determine whether a carrier is in the detection proximity of the platform; and
perform background radiation calculations if a carrier is not in the detection proximity of the platform.

38. The logic of claim 37, wherein the logic is further operable to refuse to initiate an alarm for an illicit metallic object if a carrier is not in the detection proximity of the platform.

39. The logic of claim 37, wherein the logic is further operable to instruct a signaling device to generate a signal to inform a carrier to proceed with scanning if scanning of a carrier is complete.

40. The logic of claim 31, wherein the logic is further operable to instruct an alarm subsystem to generate a user intelligible signal if an illicit object may be in the detection proximity of the platform.

41. A system for scanning carriers for objects, comprising:
means for sensing a radioactive object in the detection proximity of a platform and forming a signal indicative thereof;
means for determining whether an illicit radioactive object may be in the detection proximity;
means for sensing a metallic object in the detection proximity of the platform and forming a signal indicative thereof; and
means for determining whether an illicit metallic object may be in the detection proximity.

42. The system of claim 41, wherein the platform includes a walk-through passage.

43. The system of claim 41, wherein determining whether an illicit radioactive object may be in the detection proximity comprises determining whether the signal exceeds a threshold.

44. The system of claim 43, wherein determining whether the signal exceeds a threshold comprises comparing the radiation in the detection proximity of the platform to the background radiation in the detection proximity of the platform.

45. The system of claim 41, wherein:
sensing a radioactive object in the detection proximity of a platform and forming a signal indicative thereof comprises sensing a radioactive object in a plurality of zones of the platform and forming signals indicative thereof, each signal associated with a different zone of the platform; and
determining whether an illicit radioactive object may be in the detection proximity comprises determining whether any of the signals exceeds a threshold and, if so, determining the zone in which the object is likely to be located.

46. The system of claim 41, wherein:
sensing a metallic object in the detection proximity of the platform and forming a signal indicative thereof comprises sensing a metallic object in a plurality of zones of the platform and forming signals indicative thereof, each signal associated with a different zone of the platform; and
determining whether an illicit metallic object may be in the detection proximity comprises determining whether any of the signals exceeds a threshold and, if so, determining the zone in which the object is likely to be located.

47. The system of claim 41, further comprising means for determining whether a carrier is in the detection proximity of the platform, wherein the means for determining whether an illicit radioactive object may be in the detection proximity performs background radiation calculations if a carrier is not in the detection proximity of the platform.

48. The system of claim 47, wherein the means for determining whether an illicit metallic object may be in the detection proximity refuses to initiate an alarm for an illicit metallic object if a carrier is not in the detection proximity of the platform.

49. The system of claim 47, further comprising means for generating a signal to inform a carrier to proceed with scanning if scanning of a carrier is complete.

50. The system of claim 41, further comprising means for generating a user intelligible signal if an illicit object may be in the detection proximity of the platform.

51. A system for scanning carriers for objects, comprising:
a platform including a walk-through passage;
a metal detection subsystem coupled to the platform, the metal detection subsystem operable to sense a metallic object in the passage and to form a signal indicative thereof;
a radiation detection subsystem coupled to the platform, the radiation detection subsystem operable to sense a radioactive object in the passage and to form a signal indicative thereof; and
a processing subsystem coupled to the metal detection subsystem and the radiation detection subsystem, the processing subsystem operable to determine, based on the signals from the metal detection subsystem and the radiation detection subsystem, if an illicit object may be in the passage.

52. The system of claim 51, wherein the platform comprises a housing.

53. The system of claim 51, wherein the radiation detection subsystem comprises:
a scentillator operable to sense the presence of a radioactive object and to generate a light signal indicative thereof;
a photomultiplier tube operable to amplify the light signal; and
a photodetector operable to detect the amplified light signal and to generate an electrical signal indicative thereof.

54. The system of claim 51, wherein:
the radiation detection subsystem comprises a plurality of radiation detectors, each detector corresponding to a different zone of the platform; and
the processing subsystem is operable to determine the zone in which a sensed radioactive object is likely to be located.

55. The system of claim 51, wherein the metal detection subsystem comprises:
a magnetic field generator; and
a magnetic field detector.

56. The system of claim 51, wherein:
the metal detection subsystem comprises a plurality of magnetic field detectors, each detector corresponding to a different zone of the platform; and
the processing subsystem is operable to determine the zone in which a metallic object is likely to be located.

57. The system of claim 51, further comprising a presence subsystem coupled to the processing subsystem, the presence subsystem operable to determine when a carrier is in the passage of the platform.

58. The system of claim 57, wherein the processing subsystem is operable to:
perform background radiation calculations when the presence subsystem does not detect a carrier in the passage; and
perform radioactive object detection calculations when the presence subsystem does detect a carrier in the passage.

59. The system of claim 51, further comprising an alarm subsystem coupled to the processing subsystem, the alarm subsystem operable to generate a user intelligible signal if an illicit object may be in the passage.

60. The system of claim 59, wherein the alarm subsystem is operable to provide an indication of where an illicit object may be located on a carrier.

61. A system for scanning carriers for objects, comprising:
a user support platform;
a metal detection subsystem coupled to the platform, the metal detection subsystem operable to sense a metallic object in a localized area of a detection proximity of the platform and to form a signal indicative thereof;
a radiation detection subsystem coupled to the platform, the radiation detection subsystem operable to sense a radioactive object in the detection proximity of the platform and to form a signal indicative thereof; and
a processing subsystem coupled to the metal detection subsystem and the radiation detection subsystem, the processing subsystem operable to determine, based on the signals from the metal detection subsystem and the radiation detection subsystem, if an illicit object may be in the detection proximity of the platform.

62. The system of claim 61, wherein the platform comprises a housing.

63. The system of claim 61, wherein the radiation detection subsystem comprises:
a scentillator operable to sense the presence of a radioactive object and to generate a light signal indicative thereof;
a photomultiplier tube operable to amplify the light signal; and
a photodetector operable to detect the amplified light signal and to generate an electrical signal indicative thereof.

64. The system of claim 61, wherein the metal detection subsystem comprises:
a magnetic field generator; and
a magnetic field detector.

65. The system of claim 61, further comprising a presence subsystem coupled to the processing subsystem, the presence subsystem operable to determine when a carrier is in the detection proximity of the platform.

66. The system of claim 61, further comprising an alarm subsystem coupled to the processing subsystem, the alarm subsystem operable to generate a user intelligible signal if an illicit object may be in the detection proximity of the platform.

67. The system of claim 66, wherein the alarm subsystem provides a different signal depending on whether an illicit radioactive object or an illicit metallic object may be in the detection proximity of the platform.

68. The system of claim 61, wherein the area comprises the anal/vagina region of a carrier.

69. The system of claim 61, further comprising a second metal detection subsystem coupled to the platform, the second metal detection subsystem operable to sense a metallic object in a second localized area and to form a signal indicative thereof.

70. The system of claim 69, wherein the area comprises the oral/facial region of a carrier.

71. A system for scanning carriers for objects, comprising:
a hand-held platform;
a metal detection subsystem coupled to the platform, the metal detection subsystem operable to sense a metallic object in a detection proximity of the platform and to form a signal indicative thereof;
a radiation detection subsystem coupled to the platform, the radiation detection subsystem operable to sense a radioactive object in the detection proximity of the platform and to form a signal indicative thereof; and
a processing subsystem coupled to the metal detection subsystem and the radiation detection subsystem, the processing subsystem operable to determine, based on the signals from the metal detection subsystem and the radiation detection subsystem, if an illicit object may be in the detection proximity of the platform.

72. The system of claim 71, wherein the platform comprises a housing.

73. The system of claim 71, wherein the radiation detection subsystem comprises:
a scentillator operable to sense the presence of a radioactive object and to generate a light signal indicative thereof;
a photomultiplier tube operable to amplify the light signal; and
a photodetector operable to detect the amplified light signal and to generate an electrical signal indicative thereof.

74. The system of claim 71, wherein the metal detection subsystem comprises:
a magnetic field generator; and
a magnetic field detector.

75. The system of claim 71, further comprising a presence subsystem coupled to the processing subsystem, the presence subsystem operable to determine when a carrier is in the detection proximity of the platform.

76. The system of claim 75, wherein the processing subsystem is operable to perform background radiation calculations when the presence subsystem does not detect a carrier in the detection proximity of the platform.

77. The system of claim 71, further comprising an alarm subsystem coupled to the processing subsystem, the alarm subsystem operable to generate a user intelligible signal if an illicit object may be in the detection proximity of the platform.

78. The system of claim 76, wherein the indication is different for metallic objects and radioactive objects.

79. A system for scanning carriers for objects, comprising:
a platform including a pass-through passage;
a metal detection subsystem coupled to the platform, the metal detection subsystem operable to sense a metallic object in the passage and to form a signal indicative thereof;
a radiation detection subsystem coupled to the platform, the radiation detection subsystem operable to sense a radioactive object in the passage and to form a signal indicative thereof; and
a processing subsystem coupled to the metal detection subsystem and the radiation detection subsystem, the processing subsystem operable to determine, based on the signals from the metal detection subsystem and the radiation detection subsystem, if an illicit object may be in the passage.

80. The system of claim 79, wherein the platform comprises a housing.

81. The system of claim 79, wherein the radiation detection subsystem comprises:
a scentillator operable to sense the presence of a radioactive object and to generate a light signal indicative thereof;
a photomultiplier tube operable to amplify the light signal; and
a photodetector operable to detect the amplified light signal and to generate an electrical signal indicative thereof.

82. The system of claim 79, wherein the metal detection subsystem comprises:
a magnetic field generator; and
a magnetic field detector.

83. The system of claim 79, further comprising a presence subsystem coupled to the processing subsystem, the presence subsystem operable to determine when a carrier is in the detection proximity of the platform.

84. The system of claim 83, wherein the processing subsystem is operable to perform background radiation calculations when the presence subsystem does not detect a carrier in the passage.

85. The system of claim 79, further comprising an alarm subsystem coupled to the processing subsystem, the alarm subsystem operable to generate a user intelligible signal if an illicit object may be in the passage.

86. The system of claim 85, wherein the indication is different for metallic objects and radioactive objects.

87. A system for scanning carriers for objects, comprising:
a housing, comprising:
a first vertical support, and
a second vertical support, wherein the vertical supports define a walk-through passage;
a metal detection subsystem contained in the housing, the metal detection subsystem comprising:
an oscillator,
a magnetic field generator in the first vertical support and a magnetic field generator in the second vertical support, the generators coupled to the oscillator, wherein the generators are operable to generate a magnetic field in the passage when excited by the oscillator,
a plurality of magnetic field detectors in the first vertical support and a plurality of magnetic field detectors in the second vertical support, each detector corresponding to a different zone of the passage and operable to sense a metallic object in the passage to form a signal indicative thereof;
a radiation detection subsystem contained in the housing, the radiation detection subsystem comprising:
a plurality of scentillators in the first vertical support and a plurality of scentillators in the second vertical support, each scentillator corresponding to a different zone of the passage, the scentillators operable to sense gamma rays in the passage and to generate a light signal indicative thereof,
a plurality of photomultiplier tubes, each scentillator having an associated tube, the tubes operable to amplify the light signals, and
a plurality of photodetectors, each tube having an associated photodetector, the photodetectors operable to detect the amplified light signals and to form an electrical signal indicative thereof;
a presence subsystem coupled to the housing, the subsystem operable to detect a carrier in the passage;
a processing subsystem contained in the housing, the processing subsystem coupled to the metal detection subsystem, the radiation detection subsystem and the presence subsystem, the processing subsystem operable to:
determine, based on the signals from the metal detection subsystem, if an illicit metallic object may be in the passage and in which zone the object may be located,
determine, based on the signals from the radiation detection subsystem, if an illicit radioactive object may be in the passage and in which zone the object may be located, and
perform background radiation calculations when the presence subsystem does not detect a carrier in the passage;
an alarm subsystem contained in the housing, the alarm subsystem coupled to the processing subsystem and operable to generate a user intelligible signal if an illicit object may be in the passage, the alarm subsystem comprising:
a visual portion operable to provide an indication of where an illicit object may be located on a carrier, the indication being different for metallic objects and radioactive objects, and
an acoustic portion operable to generate a first sound if an illicit metallic object may be present and a second sound if an illicit radioactive object may be present.
